(19) United States
(12) Patent Application Publication
(10) Pub. No.: US 2024/0159274 A1
(43) Pub. Date: May 16, 2024

(54) MODULAR SUPPORT ASSEMBLY

(71) Applicant: AKTIEBOLAGET SKF, Göteborg (SE)

(72) Inventors: Pasquale Frezza, Aversa (CE) (IT); Andrea A. Bertolini, Carrara (IT); Fausto Baracca, Massa (IT)

(21) Appl. No.: 18/385,459

(22) Filed: Oct. 31, 2023

(30) Foreign Application Priority Data
Nov. 11, 2022 (IT) 102022000023283

(51) Int. Cl. F16C 35/04

(52) U.S. Cl. CPC F16C 35/042

(57) ABSTRACT

A support assembly having a central axis (X) includes a casing made of a composite material and including a radially internal mounting surface, a bearing unit provided with a radially outer ring having a radially external, spherical mounting surface, and a metal insert interposed between the casing and the bearing unit and housed inside the radially internal mounting surface of the casing. The metal insert includes a radially internal, spherical mounting surface, and the bearing unit is mounted to the radially internal, spherical mounting surface of the metal insert.

### CROSS-REFERENCE TO PRIOR APPLICATIONS

This application is based on and claims priority to Italy Patent Application No. 102022000023283 filed on Nov. 11, 2022, under 35 U.S.C. § 119, the disclosure of which is incorporated by reference herein.

### FIELD

The present disclosure relates generally to a support assembly for a bearing unit and in particular to a support assembly for applications in the food and beverage industry.

### BRIEF DESCRIPTION OF THE DRAWINGS

The disclosure will now be described with reference to the attached drawings which illustrate non-limiting exemplary embodiments of the present disclosure, in which:

FIG. 1 illustrates a top down, cross-sectional view of a support assembly according to exemplary embodiments of the present disclosure;

FIG. 2 illustrates a front view of the support assembly of FIG. 1 according to exemplary embodiments of the present disclosure;

FIG. 3 illustrates a top down, cross-sectional view of a support assembly according to exemplary embodiments of the present disclosure; and

FIG. 4 illustrates a front view of the support assembly of FIG. 3 according to exemplary embodiments of the present disclosure.

### DETAILED DESCRIPTION

In the food and beverage industry, known support assemblies for bearing units may be formed by a casing made of composite material (for example, glass fiber reinforced plastic material) and provided with a flange for fixing to the frame of a machine. Known support assemblies may further include a bearing unit housed inside the casing in order to support a moving shaft and may be provided with a spherical coupling for coupling with the casing in order to compensate for possible static mounting misalignment of the moving shaft with respect to the fixed frame of the machine.

Due to the spherical coupling, the bearing unit may not be mounted in its operating position inside a spherical mounting surface of the casing since it would interfere with the mounting surface itself. Therefore, mounting of the bearing unit is performed by inserting the bearing unit in a position rotated by 90° with respect to the operating position. The mounting surface of the casing also has a pair of insertion recesses: the presence of these insertion recesses, namely the absence of material, therefore allows rotation through 90° of the bearing unit thus inserted and positioning thereof in its operating position.

This special feature for ensuring the correct mounting of the bearing unit also helps facilitate the procedure for measuring the alignment torque of the support assembly. This test has the function of checking the degree of precision of the spherical coupling between bearing unit and casing, where, as may be deduced, the coupling may not be either too tight in order to avoid transmitting excessive tension to the moving shaft, nor too loose to ensure that the bearing unit is not movable inside the seat of the casing and, consequently, is unable to withstand and transmit the load under operating conditions.

In applications for the food and beverage industry, since the casing may be made of a composite material and is therefore subject to irregular shrinkage during cooling following the hot-molding step, correct values for correct coupling between bearing units made of metal and casings made of composite material risk nevertheless causing abrasions on the casing.

The defects present on the surfaces of the casing and in particular present on the spherical mounting surface (for example visible fractures, exposed glass fibers, etc.) are unacceptable and result in a large number of components being discarded.

Finally, in some applications, including those in the food industry, the end user on occasions may reduce or increase the size of the shaft (and consequently of the bearing unit) without having to change the machine frame. As a result, it is impossible to find a feasible solution for adapting a different-size bearing unit within the same casing. In particular, should there be an increase in the dimensions of the shaft and the bearing unit, it is not possible to imagine re-machining the casing mounting surface in order to widen it, without affecting the rest of the casing: the high degree of vibrations would reduce the strength of the casing itself.

It is therefore an object of the present disclosure is to provide a support assembly for applications in the food industry which does not have the aforementioned drawbacks.

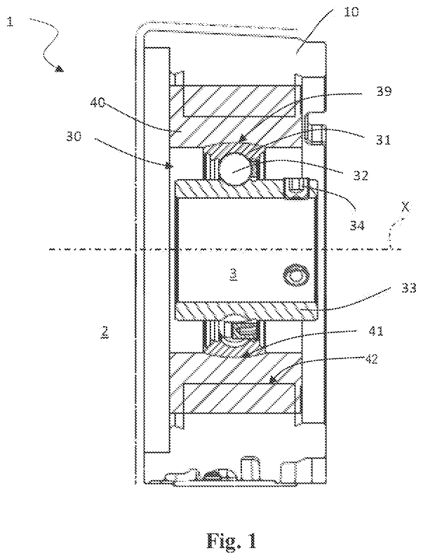

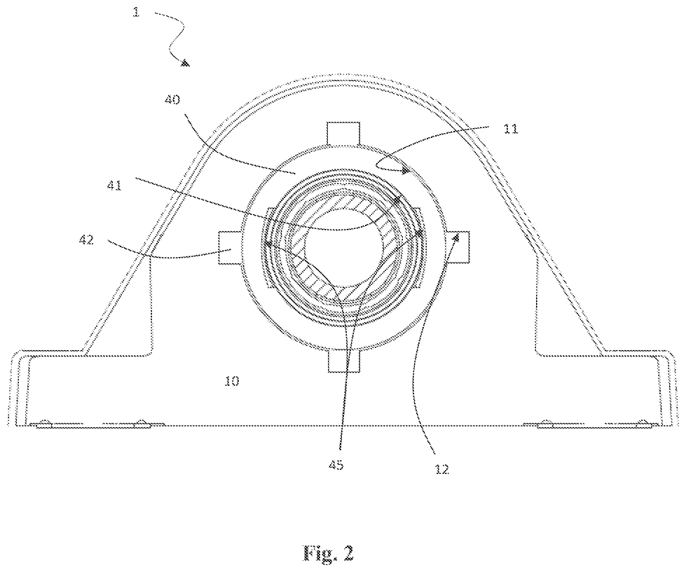

In some embodiments, with reference to FIGS. 1 and 2, a support assembly 1 may be arranged between a first mechanical element 2 and a second mechanical element 3. In some embodiments, the first mechanical element 2 may be a stationary frame 2 and second mechanical element 3 may be a rotating shaft 3. In some embodiments, a support assembly described in accordance with this disclosure is particularly suitable to applications in the food and beverage industry. However, use of a support assembly consistent with this disclosure is not limited to such uses, and a person of ordinary skill in the art will appreciate that the support assembly, e.g., support assembly 1, may be applied to any practical application as appreciated by a skilled artisan.

As illustrated in FIG. 1, in some embodiments, support assembly 1 having a central axis X may include a flanged casing 10 that is suitable for mounting on first mechanical element 2 (e.g., stationary frame 2) and provided with a radially internal mounting surface 11. Support assembly 1 may further include a metal insert 40 (see, e.g., FIG. 2), mounted inside radially internal mounting surface 11 of casing 10 and including a radially internal, spherical, mounting surface 41, and a bearing unit 30 mounted inside spherical mounting surface 41 serving as support for second mechanical element 3 (e.g., rotating shaft 3). In some embodiments, bearing unit 30 may be provided with a pair of sealing devices, each arranged on opposite sides of bearing unit 30 in order to prevent entry of fluids or contaminants inside bearing unit 30. In some embodiments, flanged casing 10 may be made of a composite material.

In some embodiments, bearing unit 30 in turn may include a convex and stationary radially outer ring 31 provided with a radially external, spherical, mounting surface 39, a radially inner ring 33, rotatable about central axis X of support assembly 1 and provided with a fixing device 34 for fixing bearing unit 30 to second mechanical element 3 (e.g., a rotating shaft 3), and a plurality of rolling bodies 32 arranged between radially outer ring 31 and radially inner ring 33 to facilitate relative rotation of radially inner ring 33 with respect to radially outer ring 31. In some embodiments, rolling bodies 32 may be balls. In some embodiments, bearing unit 30 includes a central axis of rotation that coincides with central axis X of support assembly 1. As such, the present disclosure axis X refers to both the central axis of rotation of bearing unit 30 and the central axis of support assembly 1.

Throughout the present description and in the claims, the terms and the expressions indicating positions and orientations such as “radial” and “axial” are understood as being in relation to central axis of rotation X of bearing unit 30.

Therefore, as illustrated in FIG. 2, metal insert 40 of support assembly 1 according to the present disclosure may be interposed radially between casing 10 and bearing unit 30. In this way, the mounting of bearing unit 30 inside spherical mounting surface 41 of casing 10 and setting of a correct alignment torque do not create problems because the spherical coupling between radially external, spherical, mounting surface 39 of radially outer ring 31 and radially internal, spherical, mounting surface 41 of metal insert 40 is realized between two metal surfaces and therefore may be sufficiently precise without creating damage to one of the two surfaces (e.g., surfaces 39 and 41).

Advantageously, in some embodiments, casing 10 is co-molded with metal insert 40.

In some embodiments, metal insert 40 may be made as a single piece and may include a pair of insertion recesses 45 configured to allow insertion of bearing unit 30 inside spherical mounting surface 41 and enable rotation of bearing unit 30 itself during insertion to position bearing unit 30 properly in a mounted configuration. In some embodiments, insertion recesses 45 may be formed along a radially outer surface of spherical mounting surface 41 of metal insert 40 on radially opposite sides of casing 10. Insertion recesses 45 may have an annular shaped with an angular opening of approximately 30°.

Mounting of bearing unit 30 is performed by inserting bearing unit 30 into metal insert 40 in a first position and then rotating bearing unit 30 by 90° to an operating position. Insertion recesses 45 allows bearing unit 30 to be inserted into the first position and then rotated 90° to the operating position.

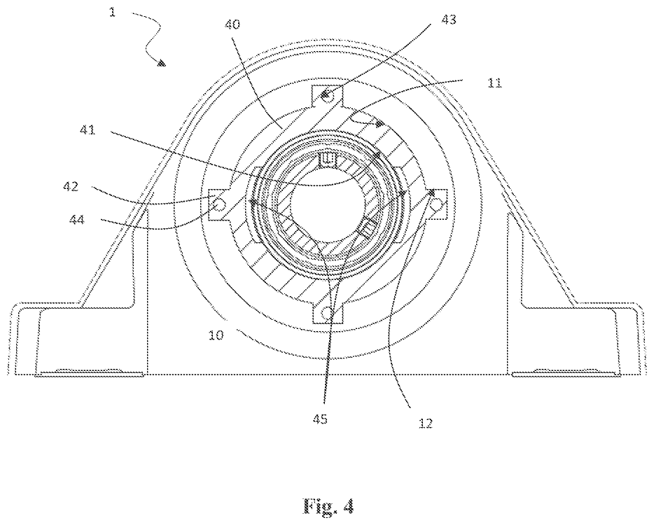

In some embodiments, metal insert 40 further includes a plurality of radially external protuberances 42 having a substantially parallelepiped shape. In some embodiments, there may be four protuberances 42 that are uniformly distributed at an angular distance of 90° from each other about metal insert 40 (see, e.g., FIG. 2, FIG. 4). Each protuberance 42 may form, along mounting surface 11 and during co-molding of casing 10, a respective radially internal anchoring groove 12 into which respective protuberances 42 sit and prevent rotation of casing 10 with respect to metal insert 40.

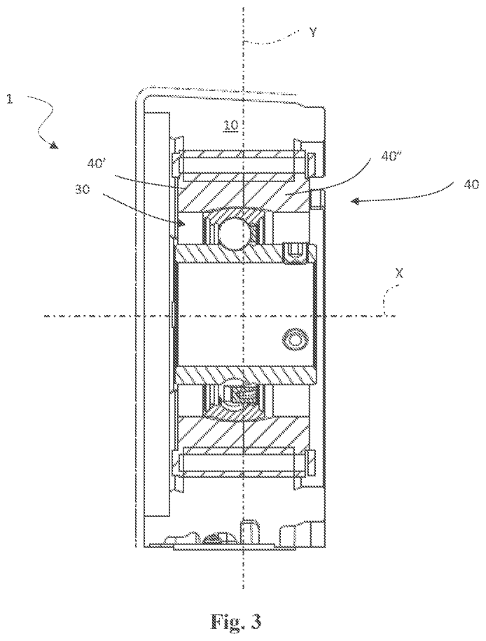

With reference to FIG. 3, in some embodiments, metal insert 40 may be formed as two half-shells 40′ and 40″, each with a substantially semi-cylindrical shape and arranged adjacent to each other about an axis of symmetry Y that is transverse to support assembly 1. Advantageously, use of two separate half-shells 40′ and 40″ to form metal insert 40 allows bearing unit 30 to be mounted first and directly in its operating position (i.e., without first mounting bearing unit 30 in the first position) followed by installation of each half-shell 40′ and 40″ around it.

In some embodiments, each of half-shell 40′ and 40″ may be provided with a plurality of radially external protuberances 42, each of which has a corresponding through-hole 43 through which a connecting pin 44 may be fed to lock half-shells 40′ and 40″ together.

In embodiments where metal insert 40 is made of half shell 40′ and half shell 40″, similar to embodiments where metal insert 40 is a single piece, each protuberance 42 may form, along mounting surface 11 and during co-molding of casing 10, a respective radially internal anchoring groove 12 into which respective protuberances 42 sit (as shown in FIG. 2), preventing rotation of casing 10 with respect to metal insert 40.

In some embodiments, there are four protuberances 42 and four corresponding through-holes 43 for each half-shell 40′ and 40″ each being angularly spaced at 90° about axis X of casing 10. In such embodiment, connecting pins 44 are also four in number and angularly spaced at 90° when inserted into through-holes 43.

Thus, in embodiments where metal insert 40 is made of half shells 40′ and 40″, protuberances 42 perform two functions: they house through-holes 43 and connecting pins 44 to facilitate securing half shells 40′ and 40″ together and they prevent rotation of metal insert 40 within casing 10 (as they do in embodiments where metal insert 40 is formed of a single piece).

Advantageously, the operation of co-molding casing 10 may be performed after bearing unit 30 and half-shells 40′ and 40″ have been mounted together.

In some embodiments, as illustrated in FIG. 4, each half-shell 40′ and 40″ may also be provided with two insertion recesses 45 configured to allow insertion of bearing unit 30 inside spherical mounting surface 41 after half shells 40′ and 40″ have been assembled together. In such embodiments, as with embodiments where metal insert 40 is a single piece, bearing unit 30 may be inserted into metal insert 40 in a first position and then rotated 90° to position it in the operating position. Insertion recesses 45 may be formed along spherical mounting surface 41 of each half-shells 40′ and 40″ of the metal insert 40 and may have an annular shaped with an angular opening of approximately 30°.

Because bearing unit 30 can be mounted directly into its operating position within half shells 40′ and 40″, use of insertion recesses 45 in such embodiments is not necessary but is an alternative embodiment.

Due to the presence of insertion recesses 45, however, it is possible to achieve standardization of the production, with the possibility of performing, as required, mounting of bearing unit 30 together with half-shells 40′ and 40″ and co-molding casing 10 onto this subassembly (i.e., bearing unit 30 and metal insert 40) or, vice versa, (i.e., co-molding casing 10 with half shells 40′ and 40″ and then mounting bearing unit 30 inside that sub-assembly).

Whether metal insert is formed as a single piece or by two half shells 40 and 41, a support assembly 1 consistent with the present disclosure enables a set of modular configurations in which mounting surface 11 of casing 10 always has the same diameter. At the same time, metal insert 40 may be adapted to different configurations based on configurations of second mechanical element 2 (e.g., moving shaft 2) and consequent bearing units 30 with varying diameters of spherical mounting surface 39 of radially outer ring 31. In other words, the diameter of spherical mounting surface 41 of metal insert 40 is not predefined, but in each case is adapted to be equal or substantially equal to the diameter of spherical mounting surface 39 of radially outer ring 31 of bearing unit 30.

To summarize, the inventive concepts disclosed in the present disclosure offer the following advantages: standardizing the casing by providing, for the solutions which require it, only one or more seats for housing the protuberances of the metal insert; modularity is obtained by providing different metal inserts which differ only in terms of the diameter of the radially internal, spherical, mounting surface that will house corresponding bearing units with a different-sized spherical mounting surface; and, in the configuration of the metal insert formed by two half-shells, the axial tightening together of the two metal half-shells is ensured by the presence of the connecting pins and the insertion recesses for subsequent mounting of the bearing unit are not necessarily required, simplifying production and use. This solution guarantees both a high nominal load and easy mounting.

Finally, with this solution, correct values of alignment torque are obtained without risk of damaging the casing. Accordingly, the drawbacks of known support assemblies are overcome by the support assemblies consistent with this disclosure.

In addition to the embodiments of the disclosure, as described above, it is to be understood that numerous further variants exist. It may also be understood that said embodiments are only examples and do not limit either the scope of the disclosure, nor its applications, nor its possible configurations. On the contrary, although the description provided above enables the person skilled in the art to implement the present disclosure at least in one of its examples of configuration, it will be understood that numerous variations of the components described are feasible, without thereby departing from the scope of the disclosure, as defined in the accompanying claims, interpreted literally and/or in accordance with their legal equivalents.

It should be noted that the use of particular terminology when describing certain features or embodiments of the disclosure should not be taken to imply that the terminology is being re-defined herein to be restricted to include any specific characteristics of the features or embodiments of the disclosure with which that terminology is associated. Terms and phrases used in this disclosure, and variations thereof, especially in the appended claims, unless otherwise expressly stated, should be construed as open-ended as opposed to limiting. As examples of the foregoing, the term “including” should be read to mean “including, without limitation,” “including but not limited to,” or the like; the term “comprising” as used herein is synonymous with “including,” “containing,” or “characterized by,” and is inclusive or open-ended and does not exclude additional, unrecited elements or method steps; the term “having” should be interpreted as “having at least”; the term “such as” should be interpreted as “such as, without limitation”; the term “includes” should be interpreted as “includes but is not limited to”; the term “example” is used to provide exemplary instances of the item in discussion, not an exhaustive or limiting list thereof, and should be interpreted as “example, but without limitation”; adjectives such as “known,” “normal,” “standard,” and terms of similar meaning should not be construed as limiting the item described to a given time period or to an item available as of a given time, but instead should be read to encompass known, normal, or standard technologies that may be available or known now or at any time in the future; and use of terms like “preferably,” “preferred,” “desired,” or “desirable,” and words of similar meaning should not be understood as implying that certain features are critical, essential, or even important to the structure or function of the present disclosure, but instead as merely intended to highlight alternative or additional features that may or may not be utilized in a particular embodiment.

Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. The terms “about” or “approximate” and the like are synonymous and are used to indicate that the value modified by the term has an understood range associated with it, where the range may be ±20%, ±15%, ±10%, ±5%, or ±1%. The term “substantially” is used to indicate that a result (e.g., measurement value) is close to a targeted value, where close may mean, for example, the result is within 80% of the value, within 90% of the value, within 95% of the value, or within 99% of the value. Also, as used herein “defined” or “determined” may include “predefined” or “predetermined” and/or otherwise determined values, conditions, thresholds, measurements, and the like.

We claim:

1. A support assembly with a central axis (X), the support assembly comprising:
a casing made of a composite material and comprising a radially internal mounting surface;
a bearing unit provided with a radially outer ring comprising a radially external, spherical mounting surface; and
a metal insert interposed between the casing and the bearing unit and housed inside the radially internal mounting surface of the casing, the metal insert comprising a radially internal, spherical mounting surface,
wherein the bearing unit is mounted to the radially internal, spherical mounting surface of the metal insert.

2. The support assembly of claim 1, wherein the metal insert is made of a single piece and further comprises:
two insertion recesses formed along the spherical mounting surface of the metal insert and configured to receive the bearing unit in a first position when the bearing unit is mounted inside the spherical mounting surface,
wherein the bearing unit is configured to be rotated 90° from the first position to an operating position in which the bearing unit cannot be removed from the metal insert at the two insertion recesses.

3. The support assembly of claim 2, wherein the metal insert further comprises:
a plurality of radially external protuberances having a substantially parallelepiped shape, which, during operation, are housed in respective anchoring grooves formed on the mounting surface of the casing.

4. The support assembly of claim 3, wherein the plurality of protuberances are four in number and uniformly distributed at an angular distance of 90° from each other.

5. The support assembly of claim 1, wherein the metal support comprises two half-shells with a substantially semi-cylindrical shape, arranged adjacent to each other and symmetrical with each other relative to an axis of symmetry (Y) transverse to the support assembly.

6. The support assembly of claim 5, wherein each of the two half-shells comprises:
a plurality of radially external protuberances, with a substantially parallelepiped shape, each protuberances comprising a corresponding through-hole through which a connecting pin is received to lock the two half-shells together.

7. The support assembly of claim 6, wherein the protuberances, the corresponding through-holes, and the connecting pins are four in number for each half-shell and are angularly spaced at 90° from each other.

8. The support assembly of claim 6, wherein each of the two half-shells of the metal insert further comprises two insertion recesses formed along each respective spherical mounting surface.

9. The support assembly of claim 7, wherein each of the two half-shells of the metal insert further comprises two insertion recesses formed along each respective spherical mounting surface.

10. The support assembly of claim 4, wherein,
the diameter of the mounting surface of the casing is predefined, and
the diameter of the spherical mounting surface of the metal insert is not predefined but is substantially equal to the diameter of the spherical mounting surface of the radially outer ring of the bearing unit.

11. The support assembly of claim 8, wherein,
the diameter of the mounting surface of the casing is predefined, and
the diameter of the spherical mounting surface of the metal insert is not predefined but is substantially equal to the diameter of the spherical mounting surface of the radially outer ring of the bearing unit.

12. The support assembly of claim 4, wherein the casing is co-molded with the metal insert.

13. The support assembly of claim 7, wherein the casing is co-molded with the metal insert.
